(19) United States
(12) Patent Application Publication
(10) Pub. No.: US 2024/0345912 A1
(43) Pub. Date: Oct. 17, 2024

(54) PREDICTION DEVICE, PREDICTION METHOD, PREDICTION PROGRAM, AND RECORDING MEDIUM

(71) Applicant: KYOCERA Corporation, Kyoto-shi, Kyoto (JP)

(72) Inventors: Saki AYASHIRO, Kyoto-shi, Kyoto (JP); Tomonari OGAMI, Kyoto-shi, Kyoto (JP); Koji KURATA, Kyoto-shi, Kyoto (JP)

(21) Appl. No.: 18/292,545

(22) PCT Filed: Aug. 1, 2022
(86) PCT No.: PCT/JP2022/029458

§ 371 Date: Jan. 26, 2024

(30) Foreign Application Priority Data
Jul. 30, 2021 (JP) 2021-125396

(51) Int. Cl. G06F 11/07; G06F 11/14

(52) U.S. Cl. CPC G06F 11/079; G06F 11/0778; G06F 11/1438

(57) ABSTRACT

To take measures to cause an event not to occur before the event occurs. A prediction device includes an acquiring unit configured to acquire time-series data at a predetermined cycle and a prediction unit configured to perform a first prediction for predicting first time-series data for a first period after a prediction execution time point in accordance with past time-series data for a period before the prediction execution time point and a second prediction for predicting second time-series data after the first period in accordance with the past time-series data and the first time-series data.

### TECHNICAL FIELD

The present disclosure relates to a prediction device, a prediction method, a prediction program, and a recording medium.

### BACKGROUND OF INVENTION

Predicting a failure of an information processing apparatus has recently been known as described in, for example, Patent Document 1.

### CITATION LIST

### Patent Literature

Patent Document 1: JP 2021-77274 A

### SUMMARY

A prediction device according to an aspect of the present disclosure is a prediction device for predicting time-series data and includes an acquiring unit configured to acquire time-series data at a predetermined cycle and a prediction unit configured to predict time-series data to be acquired in accordance with the time-series data acquired. The prediction unit performs a first prediction for predicting first time-series data for a first period after a prediction execution time point in accordance with past time-series data that is the time-series data for a period before the prediction execution time point and a second prediction for predicting second time-series data after the first period in accordance with the past time-series data and the first time-series data.

A prediction method according to an aspect of the present disclosure is a prediction method for predicting time-series data and includes acquiring time-series data at a predetermined cycle and predicting time-series data to be acquired in accordance with the time-series data acquired. The predicting performs a first prediction for predicting first time-series data for a first period after a prediction execution time point in accordance with past time-series data that is the time-series data for a period before the prediction execution time point and a second prediction for predicting second time-series data after the first period in accordance with the past time-series data and the first time-series data.

The prediction device according to each aspect of the present disclosure may be implemented by a computer. In this case, a control program of the prediction device causing a computer to implement the prediction device by causing the computer to operate as each unit (software element) included in the prediction device and a computer-readable recording medium in which the control program is recorded are also included within the scope of the present disclosure.

### BRIEF DESCRIPTION OF THE DRAWINGS

FIG. 1 is a block diagram illustrating a configuration of main parts of a prediction device according to the present embodiment.

FIG. 2 is a diagram illustrating an outline of a server failure prediction system including the prediction device.

FIG. 3 is a diagram illustrating an outline of the server failure prediction system including the prediction device.

FIG. 4 is a diagram for explaining a prediction method in the prediction device.

FIG. 5 is a diagram for explaining details of the prediction method.

FIG. 6 is a diagram for explaining details of the prediction method.

FIG. 7 is a sequence diagram illustrating a flow of processing in the present embodiment.

### DESCRIPTION OF EMBODIMENTS

An embodiment of the present disclosure will be described in detail below.

A prediction device 20 according to the present disclosure predicts future time-series data on the basis of past time-series data. More specifically, the future time-series data is predicted from a time point after a predetermined time interval from a time point at which the prediction is executed. Predicting future time-series data allows a user to recognize an event that may occur in the future and take measures to cause the event not to occur. As a result, stop of an operation of the device can be reduced.

Hereinafter, a description will be given on the basis of an example in which the prediction device 20 of the present disclosure is applied to failure prediction of a server. Application of the present disclosure is not limited to failure prediction of a server, and may also be applied to other devices without departing from the scope of the present disclosure.

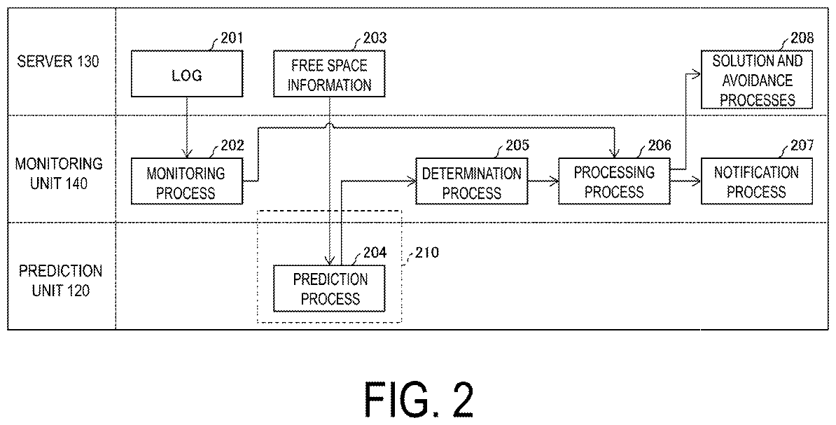

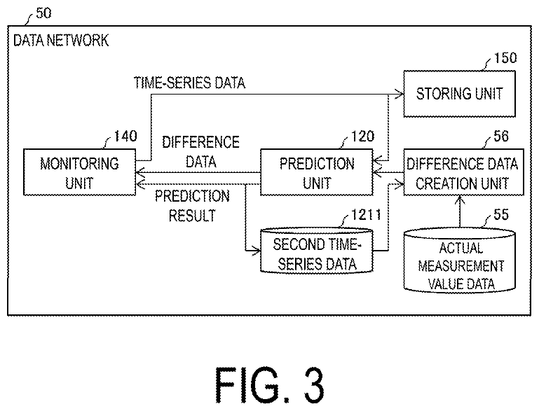

Outline First, an outline of the server failure prediction system 1 including the prediction device 20 will be described with reference to FIGS. 2 and 3. FIGS. 2 and 3 are diagrams for explaining an outline of the system 1.

The system 1 includes the prediction device 20 and a server 130. In the present embodiment, the system 1 can perform server failure prediction. As described above, the prediction device 20 can predict time-series data. The server 130 is, for example, an HDD (Hard Disc Drive) or the like, and can record various data related to product manufacturing. In the present embodiment, the server 130 records a LOG201 as log information.

In the present embodiment, the failure prediction of the server 130 will be described by exemplifying a temporal change of a free space of the server 130 such as a hard disc drive (HDD) as time-series data 2. However, the present disclosure is also applicable to the time-series data 2 other than the free space of the server 130. That is, any time-series data can be applied as long as it is time-series data.

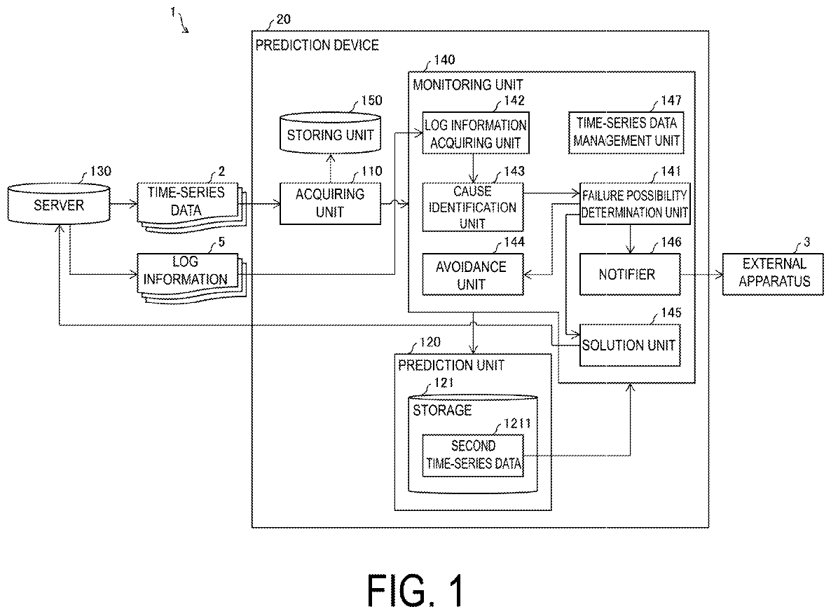

Configuration of Main Parts of Prediction Device Next, a configuration of main parts of the prediction device 20 will be described with reference to FIG. 1. FIG. 1 is a block diagram illustrating a configuration of main parts of the prediction device 20. As illustrated in FIG. 1, the prediction device 20 includes an acquiring unit 110, a prediction unit 120, a monitoring unit 140, and a storing unit 150. Although the monitoring unit 140 is included in the prediction device 20 herein, the monitoring unit 140 may be provided outside the prediction device 20.

The acquiring unit 110 acquires time-series data 2 related to the server 130, transmits the time-series data to the monitoring unit 140, and stores the time-series data in the storing unit 150. The time-series data 2 is, for example, data related to a free space of the server 130.

The monitoring unit 140 monitors the free space of the server 130, and acquires the time-series data 2 via the acquiring unit 110. The acquired time-series data 2 is transmitted to a time-series data management unit 147 of the monitoring unit 140. The time-series data management unit 147 transmits the transmitted time-series data 2 to the prediction unit 120. In addition, the monitoring unit 140 acquires log information 5 from the server 130. The monitoring unit 140 will be described in detail below.

The prediction unit 120 stores the time-series data 2 transmitted from the monitoring unit 140 in a storage 121, and predicts future time-series data using the time-series data 2. Then, second time-series data as a result of the prediction is stored in the storage 121 as second time-series data 1211. The prediction method by the prediction unit 120 will be described in detail below.

The storing unit 150 stores the time-series data 2 transmitted from the acquiring unit 110. The storing unit 150 may store the time-series data 2 for a predetermined period. The predetermined period is, for example, one year. In addition, the storing unit 150 may store an actual measurement value of the time-series data 2 as it is, or may store data obtained by processing the time-series data 2.

As described above, the system 1 includes the server 130 and the prediction device 20. The prediction device 20 includes the monitoring unit 140 and the prediction unit 120. As illustrated in FIG. 2, the monitoring unit 140 monitors the server 130 by periodically acquiring LOG201 of the server 130 (monitoring process 202). In the monitoring process 202, a cause identification unit 143 predicts a factor that is likely to be a cause of a failure of the server 130 from the LOG201.

In addition, the monitoring unit 140 acquires free space information 203 of the server 130 and transmits the free space information to the prediction unit 120. The prediction unit 120 performs prediction using the acquired free space information 203 (prediction process 204). Then, a predicted result is transmitted to the monitoring unit 140.

The monitoring unit 140 determines whether there is a possibility of a failure in the server 130 from the acquired prediction result (determination process 205). When there is a possibility of a failure, the monitoring unit 140 performs processing corresponding to a cause of the failure (processing process 206). The processing process 206 may be, for example, notification to a user terminal (notification process 207), or may cause the server 130 to perform processing for solving or avoiding the failure (solution, avoidance process 208).

Next, details of processing surrounded by a broken line 210 in FIG. 2 will be described with reference to FIG. 3. Here, as illustrated in FIG. 3, the monitoring unit 140 and the prediction unit 120 are communicatively connected to each other to form a data network 50.

As illustrated in FIG. 3, the data network 50 includes the storing unit 150 and a difference data creation unit 56, in addition to the monitoring unit 140 and the prediction unit 120. A storage in which second time-series data 1211 and actual measurement value data 55 are stored is also included.

The difference data creation unit 56 calculates a difference at the same time of day between the second time-series data 1211 predicted by the prediction unit 120 and the actual measurement value data 55 actually measured, creates difference data, and transmits the difference data to the monitoring unit 140.

The time-series data (free space information 203) from the monitoring unit 140 is transmitted to the prediction unit 120 and stored in the storing unit 150. The prediction unit 120 performs prediction processing using the free space information 203, transmits a prediction result to the monitoring unit 140, and stores the prediction result in the storage as the second time-series data 1211.

In addition, the prediction unit 120 acquires difference data from the difference data creation unit 56 that creates a difference between the actual measurement value data 55 and the prediction result, and transmits the difference data to the monitoring unit 140 as an actual measurement difference from the prediction result.

### Details of Prediction Unit 120

As described above, the prediction unit 120 predicts future time-series data using the time-series data 2 acquired from the monitoring unit 140.

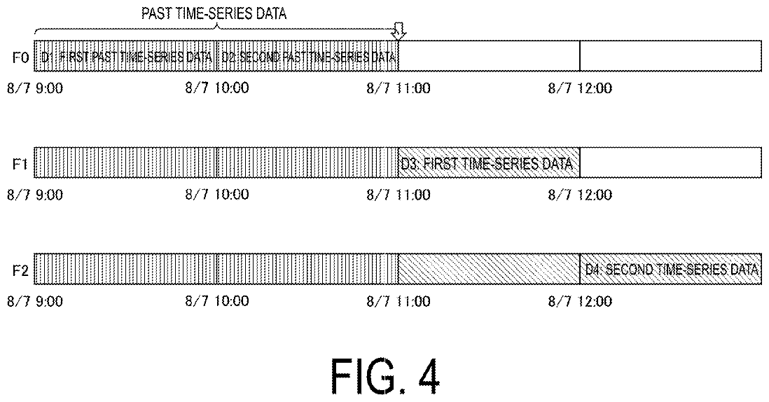

The prediction method by the prediction unit 120 will be described with reference to FIG. 4. FIG. 4 is a diagram for explaining a prediction method by the prediction unit 120.

The prediction unit 120 performs prediction using a learned model that predicts time-series data of one hour following two hours from time-series data of the two hours. Here, the time-series data of two hours is referred to as past time-series data. In addition, time-series data of a first hour of the past time-series data is referred to as first past time-series data D1, and time-series data of the remaining one hour is referred to as second past time-series data D2.

A case will be considered in which time-series data after “8/7 12:00” is predicted at a time point “8/7 11:00” illustrated in F0 of FIG. 4. First, the prediction unit 120 inputs past time-series data from two hours ago to the current time point (8/7 11:00) to the learned model, thereby predicting time-series data from the current time point to one hour later (F1, first prediction). Here, a period from the current time point to one hour later is referred to as a first period, and the prediction data in the first period is referred to as first time-series data D3. In addition, a period from two hours ago to the current time point is referred to as a past period.

Next, the prediction unit 120 inputs the second past time-series data D2 of the past time-series data and the first time-series data D3 to the learned model, thereby predicting time-series data of one hour after elapse of the first period from the current time point (F2, second prediction). One hour after the elapse of the first period from the current time point is referred to as a second period, and the prediction data for the second period is referred to as second time-series data D4.

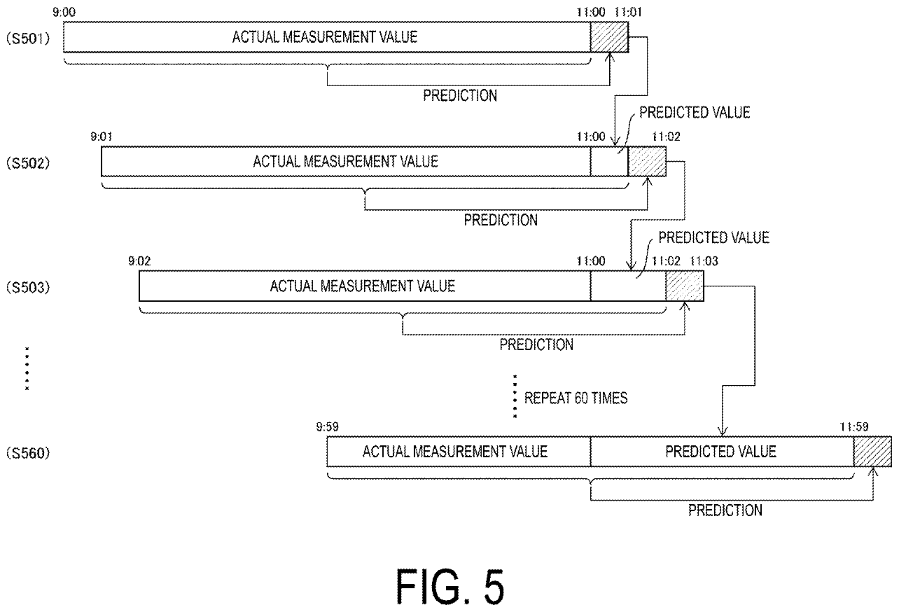

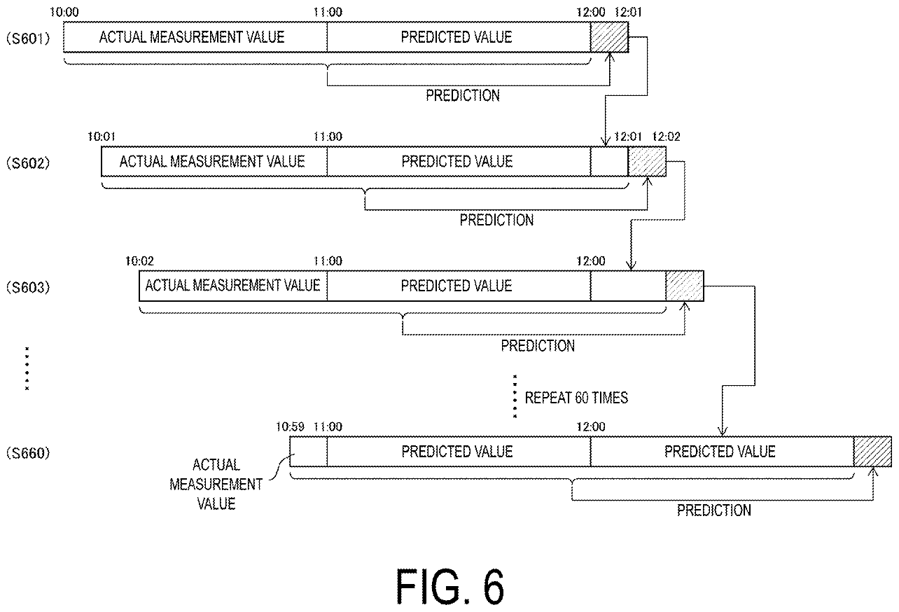

This will be described in more detail with reference to FIGS. 5 and 6.

First, the first prediction will be described with reference to FIG. 5. First, the prediction unit 120 predicts time-series data of 11:00 to 11:01 using the past time-series data that is actual measurement values of 09:00 to 10:59 (S501). Next, the prediction unit 120 predicts time-series data of 11:01 to 11:02 using the past time-series data (actual measurement values) of 09:01 to 10:59 and the predicted value of 11:00 to 11:01 that is the time-series data predicted first (S502). Furthermore, the prediction unit 120 predicts time-series data of 11:02 to 11:03 using the past time-series data of 09:02 to 10:59 and the predicted value of 11:00 to 11:02 predicted (S503). Subsequently, in the same manner, the prediction unit 120 performs prediction 60 times at intervals of one minute to perform prediction of time-series data of one hour from 11:00 to 11:59 (S560).

Next, the second prediction will be described with reference to FIG. 6. First, the prediction unit 120 predicts time-series data of 12:00 to 12:01 using the second past time-series data that is actual measurement values of 10:00 to 10:59 and the first time-series data that is the predicted value of 11:00 to 11:59 obtained by the first prediction (S601). Next, the prediction unit 120 predicts time-series data of 12:01 to 12:02 using the second past time-series data of 10:01 to 10:59, the first time-series data of 11:00 to 11:59, and the predicted value of 12:00 to 12:01 predicted (S602). Furthermore, the prediction unit 120 predicts time-series data of 12:02 to 12:03 using the second past time-series data of 10:02 to 10:59, the first time-series data of 11:00 to 11:59, and the predicted value of 12:00 to 12:02 predicted (S603). Subsequently, in the same manner, the prediction unit 120 performs prediction 60 times at intervals of one minute to perform prediction of time-series data of one hour from 12:00 to 12:59 (S660).

Then, the prediction unit 120 repeats the above-described processing every hour. That is, by the above-described processing, the processing of predicting time-series data after “8/7 12:00” is performed at the time point of “8/7 11:00”, and then the processing of predicting time-series data after “8/7 13:00” is performed at the time point of “8/7 12:00” one hour later. Thereby, without any actual measurement value from the current time point to one hour later, the time-series data from one hour later to two hours later of the current time point can be predicted every hour.

By the above-described method, the prediction unit 120 can predict the time-series data after “8/7 12:00” at the time point of “8/7 11:00”.

The learned model may use artificial intelligence (AI), particularly long short-term memory (LSTM), quasi-recurrent neural network (QRNN), or the like as an algorithm. In addition, the learned model can be generated by machine-learning a set of time-series data of two hours and time-series data of one minute thereafter as learning data for one month.

The first prediction and the second prediction may be performed using the same learned model or may be performed using different learned models. By using the same learned model in the first prediction and the second prediction, it is not necessary to prepare a plurality of learned models.

In addition, the prediction unit 120 may compare the first time-series data D3 and the second time-series data D4 with the actual time-series data 2 at the time point of the prediction result, and update the learned model when there is a difference.

In the above description, the case where the past period is two hours and the first period and the second period are one hour has been described as an example, but the present invention is not limited thereto. The first period and the second period may be periods shorter than the past period.

In other words, an amount of data of the past time-series data corresponding to the past period is equal to or larger than an amount of data of the first time-series data corresponding to the first period. In addition, the amount of data of the past time-series data is equal to or larger than a sum of the amount of data of the first time-series data and an amount of data of the second time-series data corresponding to the second period.

In addition, the first prediction is performed using the actual measurement value every hour to predict the first time-series data. That is, the first prediction at the current time point is not performed using the second time-series data obtained by prediction one hour before the current time point.

### Details of Monitoring Unit 140

The monitoring unit 140 includes a failure possibility determiner 141, a log information acquiring unit 142, a cause identification unit 143, an avoidance unit 144, a solution unit 145, a notifier 146, and a time-series data management unit 147. The monitoring process 202 described above is executed by the cause identification unit 143. In addition, the determination process 205 is executed by the failure possibility determiner 141. Furthermore, the processing process 206 is executed by the avoidance unit 144 and the solution unit 145. The notification process 207 is executed by the notifier 146.

The failure possibility determiner 141 determines whether there is a possibility that the server 130 will fail within the second period on the basis of a prediction result by the prediction unit 120 and a cause identified by the cause identification unit 143.

The log information acquiring unit 142 acquires log information 5 from the server 130.

The cause identification unit 143 identifies a cause of a failure using the log information 5. For example, when the number of pieces of log information 5 is larger than that in a normal state, the cause identification unit 143 identifies a cause from a situation of the log information 5.

When the cause identification unit 143 identifies that the cause of the failure is some data in the server 130, the avoidance unit 144 instructs deletion of the data from the server 130. Alternatively, a reboot of the server 130 is instructed.

When the cause identification unit 143 identifies that the cause of the failure is a process related to the server 130, the solution unit 145 stops or limits the process on the server 130. As an example of stopping or limiting the process, only an apparatus that is operating abnormally may be limited, or a production plan may be rearranged only by an apparatus that is operating normally. That is, a plan may be rearranged so that the production is continued only by the apparatus that is operating normally, and the apparatus that is operating normally may be operated according to a new plan.

The avoidance unit 144 and the solution unit 145 may perform processing in parallel.

The notifier 146 notifies an external apparatus 3 that there is a possibility of the failure. The external apparatus 3 is, for example, a terminal of a system administrator, a monitor for management, or the like, but is not limited thereto.

The time-series data management unit 147 processes the time-series data 2 acquired by the monitoring unit 140. Specifically, the time-series data 2 is acquired from the server 130 via the acquiring unit 110, and the acquired time-series data 2 is transmitted to the prediction unit 120.

### Flow of Prediction Processing

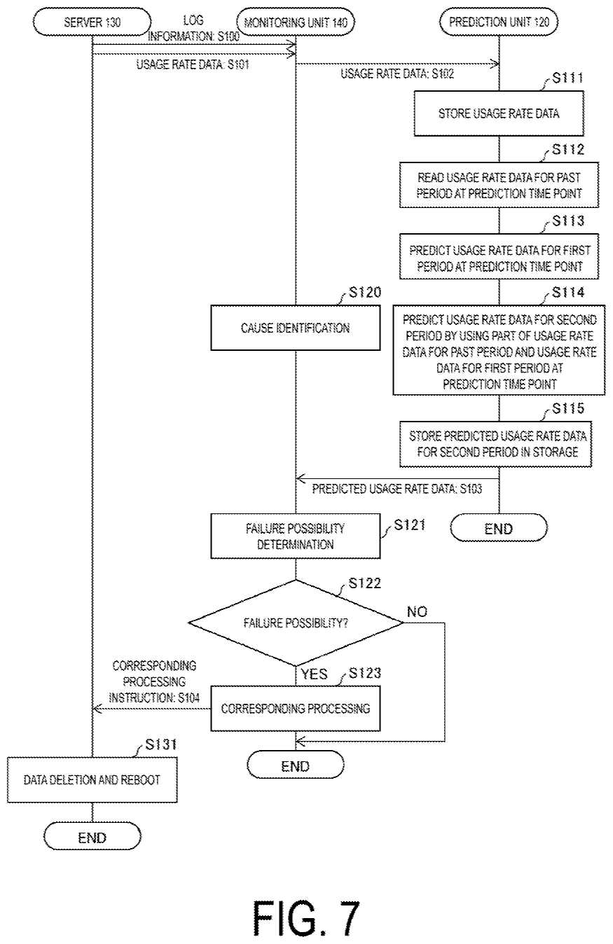

Next, a flow of prediction processing will be described with reference to FIG. 7. FIG. 7 is a sequence diagram illustrating a flow of prediction processing.

### Step S100

The monitoring unit 140 acquires the log information 5 from the server 130. The acquisition is performed periodically. ‘Periodically’ is, for example, a 10-minute cycle, but is not limited thereto.

### Step S120

The monitoring unit 140 uses the acquired log information 5 to identify a factor that is likely to cause a failure of the server 130.

### Step S101

The monitoring unit 140 acquires, for example, usage rate data as the time-series data 2 of the server 130. The acquisition is performed periodically. ‘Periodically’ is, for example, a 10-minute cycle, but is not limited thereto.

### Step S102

The monitoring unit 140 transmits the usage rate data of the server 130 to the prediction unit 120. The transmission is performed periodically. ‘Periodically’ is, for example, a 10-minute cycle, but is not limited thereto.

### Step S111

The prediction unit 120 stores the usage rate data of the server 130 in the storage 121.

### Step S112

The prediction unit 120 reads usage rate data for a past period in the storage 121. The period of data to be read may be as long as necessary for prediction.

### Step S113

The prediction unit 120 predicts usage rate data of the server 130 for the first period from the data read in step S112.

### Step S114

The prediction unit 120 reads the usage rate data for the first period and the usage rate data for the past period and predicts usage rate data for the second period.

### Step S115

The prediction unit 120 stores the predicted usage rate data for the second period in the storage 121.

### Step S103

The monitoring unit 140 acquires the usage rate data in the two periods predicted by the prediction unit 120.

### Step S121

The monitoring unit 140 determines whether there is a possibility that the server 130 will fail within the second period on the basis of the cause identified by the cause identification unit 143 and the acquired usage rate data. Regarding the usage rate data, for example, it is possible to determine whether there is a possibility of a failure using a threshold value. The threshold value may be, for example, “90%” of the capacity of the server 130.

### Step S122

When the monitoring unit 140 determines that there is a possibility of a failure in the server 130 (YES in step S122), the processing proceeds to step S123. If there is no possibility of a failure (NO in step S122), the processing is ended.

### Step S123

When there is a possibility of a failure of the server 130, the monitoring unit 140 identifies a cause of the failure and performs processing corresponding to the identified cause. In addition, a warning about the abnormality of the server 130 is notified to the external apparatus 3.

### Step S104

The monitoring unit 140 instructs the server 130 to perform the corresponding processing.

### Step S131

The server 130 performs processing instructed by the monitoring unit 140. As described above, the content of the processing may include data deletion, reboot, limit and stop of the process, and the like.

### VARIATION

The present variation will be described below. For the sake of convenience of description, members having the same functions as those of the members described in the above-described embodiment are denoted by the same reference signs, and description thereof is not repeated.

The monitoring unit 140 may compare the second time-series data D4 predicted by the prediction unit 120 with the actual measurement value at the time point of the prediction, and issue a warning if there is a difference equal to or greater than a first threshold value. When the difference between the prediction result and the actual measurement result is large, the accuracy of prediction may be low. In this case, the prediction device 20 can cause the user to recognize that the possibility of occurrence of a failure has been determined on the basis of prediction with low accuracy by notifying the user of a warning.

### Example of Software Implementation

Functions of the prediction device 20 (hereinafter, referred to as “apparatus”) can be implemented by a program for causing a computer to function as the apparatus and for causing the computer to function as each control block (particularly, each unit included in the prediction unit 120) of the apparatus.

In this case, the apparatus includes a computer including at least one control device (e.g., processor) and at least one storage device (e.g., memory) as hardware for executing the program. By executing the program by the control device and the storage device, the functions described in the embodiments are implemented.

The program may be recorded on one or more computer-readable non-transitory recording media. The recording media may or may not be included in the device. In the latter case, the program may be supplied to the apparatus via any wired or wireless transmission medium.

Some or all of the functions of the control blocks can be implemented by logic circuits. For example, an integrated circuit in which logic circuits functioning as the control blocks are formed is also included in the scope of the present disclosure. In addition to this, for example, a quantum computer can implement the functions of the control blocks.

The several types of processing described in the embodiments may be executed by artificial intelligence (AI). In this case, the AI may operate in the control device, or may operate in another device (e.g., an edge computer or a cloud server).

According to an aspect of the present disclosure, it is possible to contribute to building a foundation for industry and technical innovation, and contribute to achievement of sustainable development goals (SDGs).

The present disclosure is not limited to each of the embodiments described above, and various modifications can be made within the scope indicated by the claims, and an embodiment obtained by appropriately combining technical means disclosed in different embodiments is also included in a technical scope of the present disclosure.

### REFERENCE SIGNS

1 System
2 Time-series data
3 External apparatus
5 Log information
20 Prediction device
110 Acquiring unit
120 Prediction unit
121 Storage
130 Server
140 Monitoring unit
141 Failure possibility determiner
142 Log information acquiring unit
143 Cause identification unit
144 Avoidance unit
145 Solution unit
146 Notifier
147 Time-series data management unit
150 Storing unit
1211 Second time-series data
D1 First past time-series data
D2 Second past time-series data
D3 First time-series data
D4 Second time-series data

1. A prediction device, comprising:
an acquiring unit configured to acquire time-series data at a predetermined cycle; and
a prediction unit configured to predict time-series data to be acquired in accordance with the time-series data acquired,
wherein the prediction unit performs
a first prediction for predicting first time-series data for a first period after a prediction execution time point in accordance with past time-series data that is the time-series data for a period before the prediction execution time point and
a second prediction for predicting second time-series data after the first period in accordance with the past time-series data and the first time-series data.

2. The prediction device according to claim 1, further comprising
a monitoring unit configured to determine whether there is a possibility of a failure in a server by using the second time-series data,
wherein the time-series data is data related to the server.

3. The prediction device according to claim 2, further comprising:
a log information acquiring unit configured to acquire log information related to processing in the server; and
a cause identification unit configured to identify a cause of the failure by using the log information.

4. The prediction device according to claim 3, further comprising
an avoidance unit configured to remove the cause of the failure by performing at least one of deletion of data as the cause in the server or reboot of the server in accordance with the cause of the failure identified by the cause identification unit.

5. The prediction device according to claim 3, further comprising
a solution unit configured to remove the cause of the failure by performing at least one of stopping of a process as the cause in the server or limiting of the process as the cause in accordance with the cause identified by the cause identification unit.

6. The prediction device according to claim 2, further comprising
a notifier configured to issue a warning when the monitoring unit determines that there is a possibility of a failure.

7. The prediction device according to claim 6,
wherein the prediction unit performs the first prediction and the second prediction at a predetermined cycle, and
the notifier issues a warning when a difference between the second time-series data obtained from the second prediction and actual time-series data for the period predicted is equal to or greater than a first threshold value.

8. The prediction device according to claim 1, wherein the time-series data acquired by the acquiring unit is stored in a storing unit.

9. The prediction device according to claim 1, wherein the first period is shorter than the past period.

10. The prediction device according to claim 1, wherein the second prediction is performed in accordance with part of the past time-series data used in the first prediction and the first time-series data.

11. A prediction method for predicting time-series data, the prediction method comprising:
acquiring time-series data at a predetermined cycle; and
predicting time-series data to be acquired in accordance with the time-series data acquired,
wherein the predicting performs
a first prediction for predicting first time-series data for a first period after a prediction execution time point in accordance with past time-series data that is the time-series data for a period before the prediction execution time point and
a second prediction for predicting second time-series data after the first period in accordance with the past time-series data and the first time-series data.

12. A system for predicting time-series data, the system comprising:
a server;
the prediction device according to claim 1; and
an external apparatus,
wherein the prediction device acquires time-series data related to the server from the server at a predetermined cycle and performs the prediction, and
the external apparatus performs notification in accordance with a result of the prediction by the prediction device.

13. A control program for causing a computer to operate as the prediction device according to claim 1 and causing the computer to operate as the prediction unit.

14. A computer-readable recording medium in which the control program according to claim 13 is recorded.
